(19) United States
(12) Patent Application Publication
(10) Pub. No.: US 2009/0066491 A1
(43) Pub. Date: Mar. 12, 2009

(54) Wireless safety system for trains, buses and trucks

(76) Inventor: Demetrius Thompson, Woodland Hills, CA (US)

Correspondence Address: BERLINER & ASSOCIATES, 555 WEST FIFTH STREET, 31ST FLOOR, LOS ANGELES, CA, 90013, US

(21) Appl. No.: 12/286,036

(22) Filed: Sep. 26, 2008

Related U.S. Application Data
(63) Continuation-in-part of application No. 11/984,240, filed on Nov. 14, 2007.
Application No. 11/984,240 is a continuation of application No. 11/187,442, filed on Jul. 20, 2005, now Pat. No. 7,308,247.
Application No. 11/187,442 is a continuation-in-part of application No. PCT/US2004/010451, filed on May 5, 2004.

(51) Int. Cl. B60Q 5/00

(52) U.S. Cl. 340/435

(57) ABSTRACT

A method for improving safety in a moving vehicle comprising a train, bus or truck having a wireless device not in active voice mode and capable of receiving a signal indicative of a nearby traffic light. The following steps are exercised by means of a computer program operating within the vehicle: (a) determining if the location of the vehicle is within a predetermined distance from the traffic light; (b) determining if the vehicle is moving; and (d) issuing an audible alarm whereby a driver in the vehicle is warned of proximity to the traffic light. In particular embodiments, the program determines if the traffic light is a red light or is calculated to be red by the time the vehicle reaches the intersection. In a preferred embodiment, the wireless device is capable of receiving a GPS signal and uses the signal to provide position specific information.

### CROSS-REFERENCE TO RELATED APPLICATIONS

The present application is a continuation-in-part of application of U.S. Ser. No. 11/984,240, filed on Nov. 14, 2007, which is a continuation application of U.S. Ser. No. 11/187,442, filed on Jul. 20, 2005, now U.S. Pat. No. 7,308,247, which is a continuation-in-part application of PCT/US2004/010451, filed 5 May 2004 designating the United States; those entire applications being incorporated herein by reference.

### FIELD OF THE INVENTION

The invention relates to a system for ensuring train and bus safety.

### BACKGROUND OF THE INVENTION

My prior patent dealt with a cellular telephone system that provides enhanced safety for vehicle drivers using a cellular telephone, signaling the driver using a phone in active voice mode when a traffic signal is being approached. A number of driving-related systems were previously proposed. WO 96/01531 uses a cellular telephone system to determine the location and speed of a vehicle carrying an active cellular telephone. It is proposed that this system be used for an automatic parking system (to record the presence of a vehicle in a parking slot & charge for that parking, etc.), as a speed radar system that could automatically charge speeding violations to a user's telephone bill or as a theft deterrent to locate stolen vehicles. WO 98/16077, WO 98/25158 and WO 98/59256 disclose the use of a GPS (Global Positioning System) receiver in conjunction with the cellular network to derive similar information. Unfortunately, pure GPS systems have inadequate response times for most safety uses.

Japanese laid-open patent application H10-42371 deals with another aspect of the driving while phoning problem. That application discloses a vehicle mounted unit that jams any cellular signals while the car is in operation. Of course, this makes the reception of important calls impossible. U.S. Pat. No. 6,262,657 to Okuda et al. obviates some of these problems by automatically issuing a driver alert (received over the telephone) when driving characteristics become erratic while a cellular phone is being used. However, both of these solutions require a separate unit mounted in the vehicle. Thus, a user is not protected in rental cars or cars other than his or her usual vehicle.

Being aware of traffic signals is important not only for drivers of cars, but is often critically important for mass transportation vehicles such as trains or buses as well as for freight carrying vehicles, such as freight trains and trucks. Systems have been proposed and put into use for trains that are traveling in opposite direction on the same track to prevent them from crashing. While some sytems employ positive controls using GPS that prevent them from crashing, these have often been found to be too expensive for many municipalities, particularly where jurisdiction for trains and commuter transit vehicles share the same tracks. As an alternative to positive controls or automatic brakes, or in addition to them, traffic lights are used to prevent two trains from occupying the same track at the same place. When a traffic light is red the train approaching the light is supposed to stop, with a general rule that freight trains take priority over commuter trains. However, in a number of instances, Due to inattention, a number of disastrous train crashes have occurred and drivers of buses and trucks are also subject to inattention due to fatigue or distractions other than from talking on a cell phone.

### BRIEF SUMMARY OF THE INVENTION

The present invention overcomes the foregoing drawbacks by providing a method for improving safety in a moving vehicle comprising a train, bus or truck having a wireless device not in active voice mode and capable of receiving a signal indicative of a nearby traffic light. The following steps are exercised by means of a computer program operating within the vehicle: (a) determining if the location of the vehicle is within a predetermined distance from the traffic light; (b) determining if the vehicle is moving; and (d) issuing an audible alarm whereby a driver in the vehicle is warned of proximity to the traffic light. In particular embodiments, the program determines if the traffic light is a red light or is calculated to be red by the time the vehicle reaches the intersection. In a preferred embodiment, the wireless device is capable of receiving a GPS signal and uses the signal to provide the position of the vehicle and traffic light. In another embodiment, the program determines if the traffic light is a red light or is calculated to be red by the time the vehicle reaches the intersection.

An important feature of the invention is that no user interaction with the software is required. The software runs in the background on the phone, and alerts the user when the user's vehicle approaches an intersection controlled by a traffic signal. In its simplest embodiment the system tracks the positional relationships between the user and the intersection. In an enhanced embodiment the invention provides an additional warning if the light in the intersection is red (that is, the light prohibits the driver's entry into the intersection). This feature is provided by a communication link between the server and either the individual traffic signal or the Traffic Control System (TCS) for a city or region.

The invention issues an audible alert (such as a unique warning sound) when the driver approaches a traffic light. If the light at the intersection is red (or calculated to be red by the time the vehicle reaches the intersection), a different audible alert can be issued. The trigger distance from the intersection is selected to provide the cellular telephone user a sufficient time to make a response to the alert. In the simplest case the alert is always issued at a fixed distance from the intersection. In a more complex embodiment the system estimates the speed of the vehicle and issues the alert earlier (farther from the intersection), the faster the phone and vehicle carrying it are moving towards the intersection.

### DETAILED DESCRIPTION OF THE INVENTION

GPS is the most accurate and widespread global positioning system, accurate in most cases to 3 meters or less. A-GPS, a modification of GPS, is widely deployed in current cellular phones in order to comply with the U.S. E-911 system requirements; in the future all or almost all U.S. cellular providers or equipment manufacturers will support location-based services via A-GPS (or similar method). Latitude and Longitude coordinates for signal light-controlled intersections or other traffic features in a given overall area are stored in a database table on a server. The coordinates are sorted and indexed by relative proximity. Note that coordinates available in the State Plane system must be translated into Latitude and Longitude in order to be compatible with the latitude and longitude coordinates that are reported by a GPS system. A high-performance application server process on the server accepts incoming HTTP GET requests specifying a given coordinate in the overall area, and returns, via XML over HTTP, a subset of signal-controlled intersection coordinates in that area within a certain area radius of the input coordinate. The subset is meant to be defined by the memory constraints of the device. Upon startup, and periodically when idle, the device software runs a process using TCP/IP to send its current coordinate to the server, storing the returned signal-controlled intersection (or other traffic feature) coordinates from the server in the device's local memory. In other words, the device reports its position and receives back from the server the coordinates of intersections within a certain radius of the device (the “neighborhood”). These coordinates are stored in memory, and this set of coordinates is periodically updated as the device changes its position.

When the device is in use, the device's current coordinates are continually read from the GPS unit that is contained in, attached to, or otherwise linked with the device. This process is rapid because it utilizes standard device communication protocols (including network assistance). Each current coordinate read by the device is compared to the local set of coordinates contained on the device. If the change in coordinates read by the device indicates that the speed of the device exceeds 10 mph, that the current coordinate of the device is within 250 feet (very roughly one half to one quarter of a city block) of one of the local set of coordinates (the “alarm coordinate”) contained on the device, that the change in coordinates indicates that the device is moving towards one of the local set of coordinates stored on the device, and that the alarm coordinate of the device is not stored as the “last seen coordinate”, the device sounds an alert on the speaker of the device, and stores the alarm coordinate as the “last seen coordinate”. When the device is within 10′ of the stored “last seen coordinate” (proximity rule), the device sets the “last seen coordinate” to “none”. Of course, it is also possible to issue a visible alarm such as a bright flashing light instead of or in addition to the audible alarm. The device is independent from the server for most operations, only needing to contact the server when the device moves outside the area defined by the local set of coordinates stored on the device. The comparison of the coordinate data is much faster, because the device is storing the comparison data locally;

In my previous application, now U.S. Pat. No. 7,308,247, a cellular phone, or other voice communication device, was used and the system only issued an alert or alarm when someone was talking using the device, i.e., when the cellular phone or other device was in active voice mode. In the present invention, the device will also issue an alarm when it is in not in active voice mode. The device, whether a cellular phone or other device such as On-Star, while capable of being in active voice mode, just needs to be on. By storing the set as the “last seen coordinate”, the device will reset its memory of that coordinate when passing through the coordinate (defined by the 10′ proximity rule) and will not sound an alert when moving away from a coordinate (this prevents a warning from issuing after the vehicle passes the traffic light).

### Operation of the System

In the simplified embodiment described herein there are two basic components: the device which represents the GPS enabled cellular telephone hand set; and the server which is the repository of the intersection (or other traffic feature coordinates) and is in communication with the cellular telephone transmission system.

In commercial practice the server system would be operated by the cellular provider and would always be available. Coordinates are then loaded into the server's database. As previously explained, the coordinates are the physical locations of the intersections or other locations that the device will track and respond to. When the device is activated the program causes the device to perform the following functions. First, the device determines the coordinates of it current position using A-GPS or a standard attached or integrated GPS system. Briefly, an A-GPS (or similar) system uses network-based methods to greatly simplify GPS location detection. For example, Short Messaging Service (SMS) or a similar data transmission method is used to provide approximate position and the decoded satellite ephemeris and clock information to the GPS subsystem that forms part of the device. This allows the device to rapidly determine its position in spite of the weak signals and inability to obtain fixes on all of the GPS satellites that often plague GPS determination in a city. Once a location determination has been made, this coordinate is stored as the “center coordinate” and the device requests the “neighborhood” of intersection coordinates by supplying the center coordinate a certain radius. This radius-defined neighborhood is determined according to the amount of memory available in the device. Once this neighborhood of coordinates is available, the device continues to determine its present location and compares that location to the coordinate points in the neighborhood. When the device determines that is located within a set distance (here 250 feet) of one of the coordinates, an alarm is issued. In the demonstration implementation, the neighborhood is refreshed and a new center coordinate is stored when the device moves a distance from the current center coordinate equal to 90% of the distance of the radius of the “neighborhood.” Various other criteria can be used to alter or force the refresh. For example, if the device reaches one of the coordinates near an edge of the neighborhood, a new neighborhood is immediately requested.

The system is also intended to interact with the TCS in larger cities and towns. The simplest way for this interaction to occur is for the device to inform the server when it is approaching one of the intersections. This message would be sent shortly before the alarm to the user is issued. The server then queries the TCS to determine the current state of the traffic light (in the direction from which the device is approaching the intersection). If the light is red or about to go red, the device can then issue an additional special warning alert to the user. By providing an additional alarm concerning the existence of a red light, the user is even less likely to ignore the warning. The precise implementation of the communication with the TCS can vary depending on the number of intersections involved. If the number of intersections is relatively small, it is sufficiently efficient to issue actual inquiries concerning a given intersection. For small municipalities that do not have a master TCS, it is possible to provide individual transponders for each intersection to provide intersection status information to the server. With a large TCS it may not be practical for the server to constantly query the TCS. Instead the server software can maintain a logical representation of the TCS based on the expected frequency of signal changes at each intersection. The actual frequency of the various intersections and correct synchronization can be determined and maintained by periodically querying the TCS concerning the state of each intersection. This can be done automatically following a predetermined order of intersections so that each intersection is queried with a reasonable periodicity. The timing system used by commercial TCSs is extremely accurate so that once the “model” is established, it will be highly accurate. Alternatively, creating the software representation can be simplified by obtaining the actual intersection interval and offset phase information from the city Traffic Department.

An alternate embodiment of the invention is to offload part or all of the positional comparison to the server. Under that scenario the server would be constantly updated on the position of the hand set and would send the instructions to issue an alarm to the handset when the hand set was sufficiently close to one of the feature coordinates. The server could also interface with the TCS so that the alarm could also include information about the status of the light at the intersection. A drawback to this approach is that it would increase the amount of data traffic on the cellular network since each head set would be constantly sending positional information.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims.

1. A method for improving safety in a moving vehicle comprising a train, bus or truck having a wireless device not in active voice mode capable of receiving a signal indicative of a nearby traffic light, comprising exercising the following steps by means of a computer program operating within the vehicle:
(a) determining if the location of the vehicle is within a predetermined distance from the traffic light;
(b) determining if the vehicle is moving; and
(d) issuing an audible alarm whereby a driver in the vehicle is warned of proximity to the traffic light.

2. The method of claim 1 including the step of determining if the traffic light is a red light or is calculated to be red by the time the vehicle reaches the intersection.

3. The method of claim 1 wherein the wireless device is capable of receiving a GPS signal and uses the signal to provide position specific information.

4. The method of claim 1 in which the vehicle is a train.
